(19) United States
(12) Patent Application Publication
(10) Pub. No.: US 2010/0257008 A1
(43) Pub. Date: Oct. 7, 2010

(54) SYSTEM AND METHOD FOR A PRODUCT VENDOR RISK MATRIX

(76) Inventors: Gene Rider, Oak Brook, IL (US); John Qin, Willowbrook, IL (US); Xiao Chen, Carol Stream, IL (US); Luke Tao, Naperville, IL (US); Jackson Cheung, Toronto (CA); Erick Ramos, Chicago, IL (US)

Correspondence Address: MCGUIREWOODS, LLP, 1750 TYSONS BLVD, SUITE 1800, MCLEAN, VA, 22102, US

(21) Appl. No.: 12/751,812

(22) Filed: Mar. 31, 2010

Related U.S. Application Data
(60) Provisional application No. 61/165,747, filed on Apr. 1, 2009.

(51) Int. Cl. G06Q 10/00; G06Q 50/00

(52) U.S. Cl. 705/7; 705/348; 705/341; 705/30

(57) ABSTRACT

A total cost of ownership of a product and/or supplier and related supply chain may include a multitude of cost basis that might be quantified and rated with other comparisons. The product risk might include various factors such as quality, safety, guarantee, defect rate, and the like. The supplier risk may include quite a number of risk factors such as location, costs associate with transportation, landing fees, inspection fees, labor costs, inventory costs, and the like. Based on quantified aspects related to a product and its supplier (or supply chain), a total cost of ownership related to such product or supplier can be determined. Moreover, such as capability may be related to overall return on investment.

### CROSS REFERENCE TO RELATED APPLICATIONS

This application claims benefit and priority to U.S. Provisional Application No. 61/165,747 filed Apr. 1, 2009 and entitled SYSTEM AND METHOD FOR RISK MATRIX AND TOTAL COST OF OWNERSHIP, which is incorporated by reference herein in its entirety.

### BACKGROUND OF THE INVENTION

1.0 Field of the Invention

This invention relates generally to a system and method for determining total cost of ownership of assets and, more specifically, to a system and method for determining total cost of ownership of assets including evaluating current data and purchasing practices for aligning supply with demand.

2.0 Related Art

Early studies and cost models were utilized to determine landed costs. The models they provided were very rudimentary and were also referred to as “Price per Unit” models. A recent study by Evelyn Thomchick at The Center for Supply Chain Research at Penn State University was a significant contribution to understanding the attributes of landed costs as well as how various companies are utilizing landed cost models for decision support systems (DSS). Michael Lamoureux, a noted publisher of supply chain costs might call this study a model for Total Cost of Acquisition. This refined methodology goes further into allocating costs related to sourcing as well as other transactional costs than previous models. In addition, some previous Total Cost of Ownership models (TCO) were developed to evaluate the true cost of ownership of assets such as IT systems or manufacturing equipment. In these cases the rewards of ownership are typically evaluated against the lifetime costs of ownership to determine the return on investment (ROI). The product with the highest ROI was chosen. In some more recent cases TCO models have been developed to include additional supply chain costs and the goal was for decision optimization in the sourcing strategy. The previous models were utilized to make simple decisions optimizing the supply chain and operational costs. Also, current models do not reflect Supply Chain Reference Model (SCOR) of plan, source, make, deliver, return. Moreover, these current models do not address issues in the retail industry.

### SUMMARY OF THE INVENTION

The invention provides a solution to the problems associate with the prior art and provides a technique for improving return on investments and provides a technique for decision making for altering a product or supplier or other aspect of a supply chain.

In one aspect, a system including a processor and memory is provided for computing total cost of ownership including a plurality of components in the system to compute landed costs of at least one product, compute presales cost of the at least one product, compute a cost of return of the at least one product, compute a supplier cost of defective returns, generate risk levels associated with the at least one product and compute and output a total cost of ownership based at least in part on the above steps so that a change in a supply channel or a product occurs, wherein the each component is embodied as part of a computer platform.

In another aspect, a computer program product embodied on computer storage medium for computing a total cost of ownership is provided, the computer program product including computer instructions that when executed performs the steps of computing a total landing cost for at least one product, computing a presales cost for the at least one product, computing a product life cycle management cost for the at least one product, computing a cost of returns for the at least one product, computing a supplier cost for defective returns for the at least one product and computing a cost associated with quality for the at least one product, and computing total cost of ownership by summing a result from each step, wherein each of the steps when executed are configured to be performed by a computer.

In another aspect, a computer program product embodied on computer storage medium for computing a total cost of ownership is provided, the computer program product includes computer instructions that when executed performs the steps of determining a product risk for at least one product, determining a supplier risk associated with the at least one product and generating an overall risk based on the determined product risk and the determined supplier risk to cause a change in one of the at least one product and the supplier, wherein each of the steps are configured to be executed by a computer.

### BRIEF DESCRIPTION OF THE DRAWINGS

The accompanying drawings, which are included to provide a further understanding of the invention, are incorporated in and constitute a part of this specification, illustrate embodiments of the invention, and together with the detailed description, serve to explain the principles of the invention. No attempt is made to show structural details of the invention in more detail than may be necessary for a fundamental understanding of the invention and the various ways in which it may be practiced. In the drawings:

FIGS. 1A-1I are illustrations of an embodiment of a spreadsheet tool for capturing and/or calculating various costs or attributes of the Total Cost of Ownership Model, configured according to principles of the invention;

FIG. 2A is a flow diagram showing an embodiment of a process, performed according to principles of the invention;

FIG. 2B is a flow diagram showing an embodiment of a process, performed according to principles of the invention, showing a Risk Matrix that includes computing a risk assessment.

FIG. 3 is a functional block diagram showing participants of the overall process, and exemplary cost data that may be involved in the various stages, configured and performed according to principles of the invention; and

FIG. 4 is a diagram conceptually showing exemplary factors comprising a supply system cost.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

It is understood that the invention is not limited to the particular methodology, protocols, devices, apparatuses, materials, applications, etc., described herein, as these may vary. It is also to be understood that the terminology used herein is used for the purpose of describing particular embodiments only, and is not intended to limit the scope of the invention. It must be noted that as used herein and in the appended claims, the singular forms “a,” “an,” and “the” include plural reference unless the context clearly dictates otherwise.

Unless defined otherwise, all technical and scientific terms used herein have the same meanings as commonly understood by one of ordinary skill in the art to which this invention belongs. Preferred methods, devices, and materials are described, although any methods and materials similar or equivalent to those described herein can be used in the practice or testing of the invention.

The model and tool configured and performed according to principles of the invention (generally, “TCO Model” also know as “Product Vendor Risk Matrix) may include providing for estimating the total cost associated with the design, production and distribution of products. The cost estimates may be obtained using worksheets, for example, that capture cost information for landing, pre-sales, life-cycle, returns, reverse flow and other cost categories. The work sheets may break down each cost category into components and may provide cost estimates at each step in the sourcing process. The model may also provide for “what-if” optimization (simulations).

The model and tool configured and utilized according to principles of the invention may include evaluating the risk associated with product sourcing and provides risk mitigation schemes. The tool may evaluate a product's influential parameters (e.g. type, quality, safety, quantity, brand, cost, warranty, etc) and a supplier's influential parameters (e.g. country of manufacture, experience, quality systems, security, etc.) and provides risk estimates. The estimates may be used to develop a risk management plan (QMP) that optimizes the delivery of safe, good, on-time products into the market-place.

The TCO may be configured and performed according to principles of the invention goes further and includes performing spend analysis in determining best choices of suppliers and products from a Highest Value to Cost Ratio approach. This approach may determine how to maximize the supply chain for an enterprise. However, a supply chain optimization process could be misleading. A more effective model optimizes choices within the integrated organization so that the effectiveness of the decisions of the organization and integrated approach of the results of the organization may be optimized, as opposed to optimization of only the supply chains landed costs. By utilizing this model configured and performed according to principles of the invention, the capability of performing an integrated enterprise optimization study may be available versus a decision optimization process for the supply chain alone. In the latter, a determination of the value of specific products in respect to the goals and strategies of the supply chain may be performed. In the former, the capability of analyzing the integrated enterprise may be present and therefore the optimization decision may have broader company implications.

The TCO model may allow a generally unbiased approach to analyzing the results of various decisions within a corporation or enterprise. This review is only possible in the last few years as the capability to get more granular data has occurred that is relevant and timely. By integrating this model into the sourcing process decisions related to sourcing may actually result in higher landed costs. For example, obtaining shorter lead times for products that have very short life cycles by near sourcing products may result in higher landed costs but will increase enterprise revenue and profits more than the increase in the landed costs. Combining this analysis with effective benchmarking can also supply information on specific products or categories success in the market place than can not be improved by efforts in the supply chain alone. The spend analysis performed in this process may be beneficial and gives significant information to management of the effectiveness of the supply chain and marketing strategies, such as are they in alignment with each other and second, identifying results to determine their success or lack of success. In one aspect, a benefit of the model may be its ability to simulate decisions across the enterprise. Looking backwards in time is one thing. Looking forward to make decisions with a proven model may dramatically increase the chance of success of a product or product line.

This ability may be especially appropriate for the retail industry and consumer products. In many retail companies the impact of procurement and quality decisions may not be holistically reviewed. This detachment might lead to inferior decision making where per unit price becomes the key metric. Historically, a capability to relate after sales results has been hampered by data collection. This has changed as business intelligence software has increased retailers capabilities.

Although tremendous strides have been made in obtaining data in a timely manner, there still exists difficulty in getting sufficiently granular information for obtaining needed information related to the TCO model. However, the utilization of product categories may certainly aid in getting approximate cost data that very closely resembles reality. In addition, utilization of Pareto concepts to determine products to test in the model is advised and the information should be available. Some of the required data input may also be obtained by utilizing expert opinion within the company. In several cases the cost in question is relatively low in absolute value and utilizing constants of low value are not critical to the end result

In one aspect, the value of the Total Cost Model may reside in its ability to be a proactive approach through simulation and the ability to analyze current data and the relationships of purchasing practices to the successful understanding and alignment of supply to demand. It also has implications for the optimization of costs and the needs of the retailer. For example, a study of a product or of a categories return rates could indicate that a change in approach to quality spend may increase or decrease the costs of quality but the resultant decrease in return rates would have a favorable ROI. This may indicate that landed costs may initially increase but total costs (including supplier costs) may be lowered. Focused analysis of appropriate product categories could certainly result in an improved bottom line as well as brand name enhancement.

Most firms or companies now have the ability to review if the sourcing decisions are contributing to favorable or unfavorable results in product life cycle management. Designing a flexible supply chain may be critical to many products and product lines. Much can be learned by analyzing the results of sourcing decisions. However, this analysis needs to be performed in a very cross enterprise review to understand what other decision making factors significantly contributed to the results measured. The TCO model can be of significant aid in this analysis and once the relationships within the enterprise are understood than simulation can be very rewarding and effective.

The model may be important in illustrating to the decision making employees at the lowest levels the impact their decisions have within the entire enterprise. It also may also be a tool to allow management to see the results of the decisions in an economic model. This gives tremendous transparency to the supply chain and how well the supply chain strategy is aligned to the business strategy and achieving its goals.

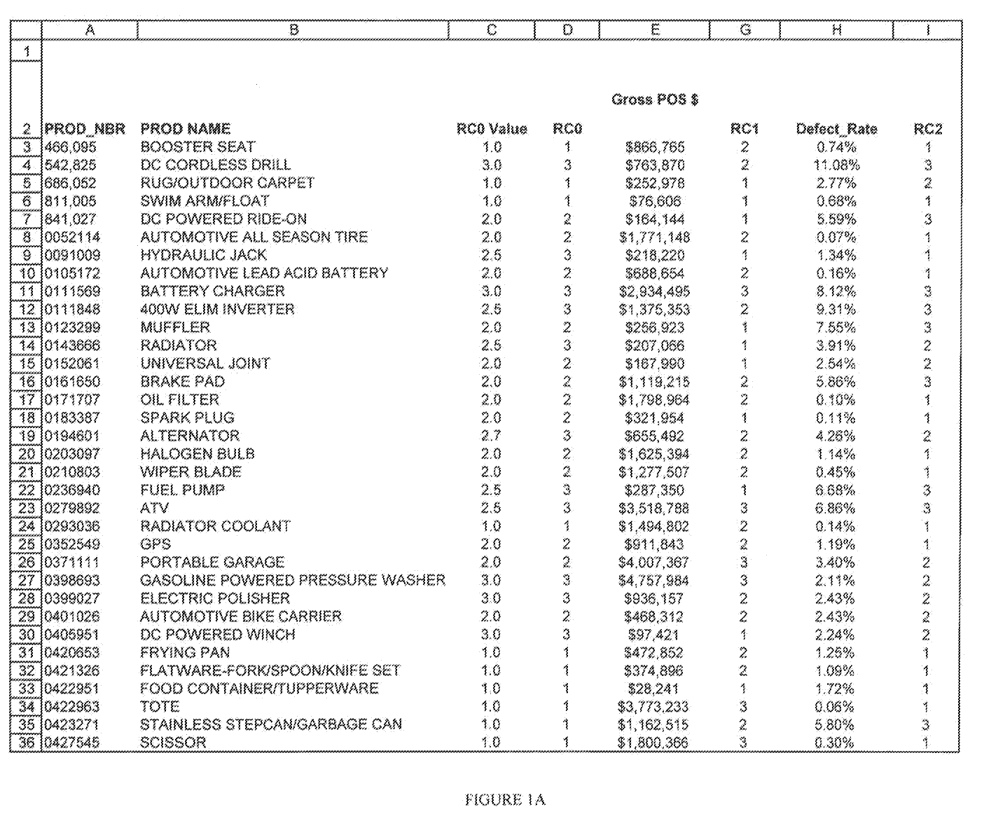

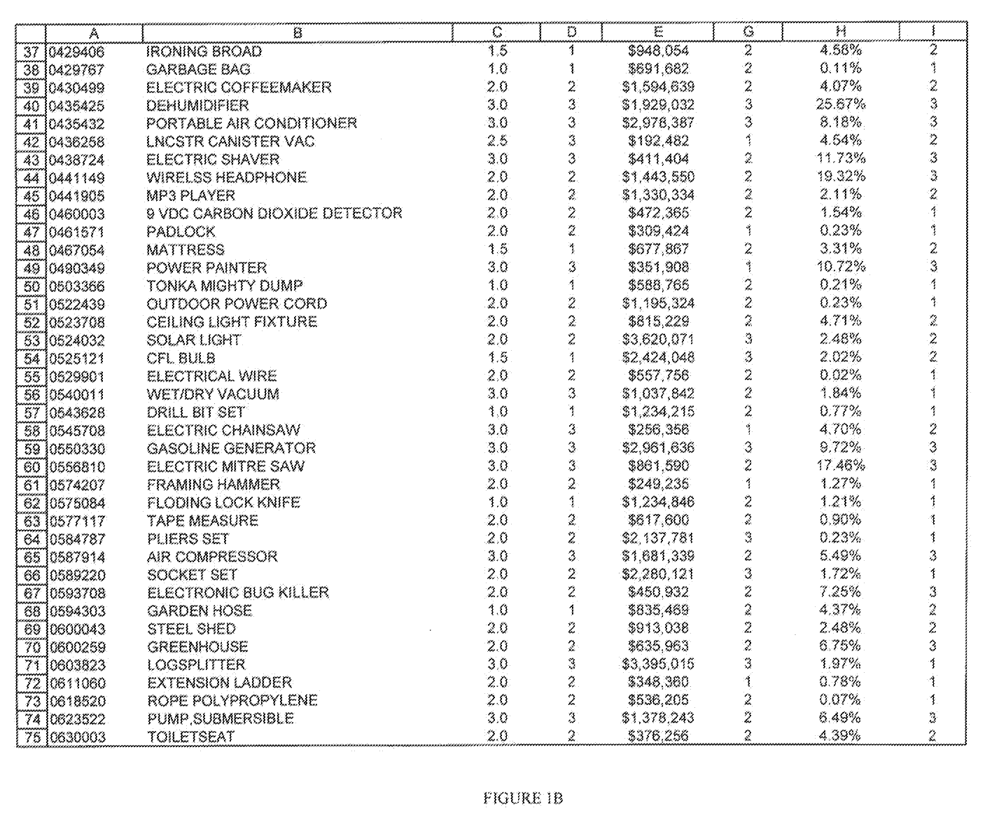

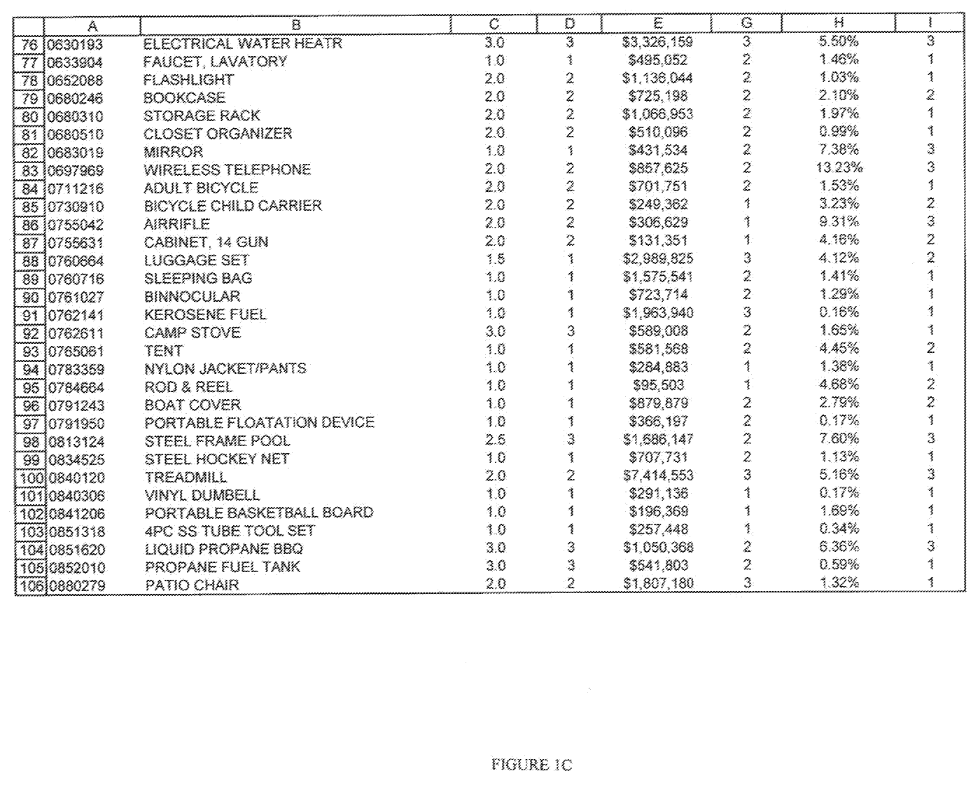

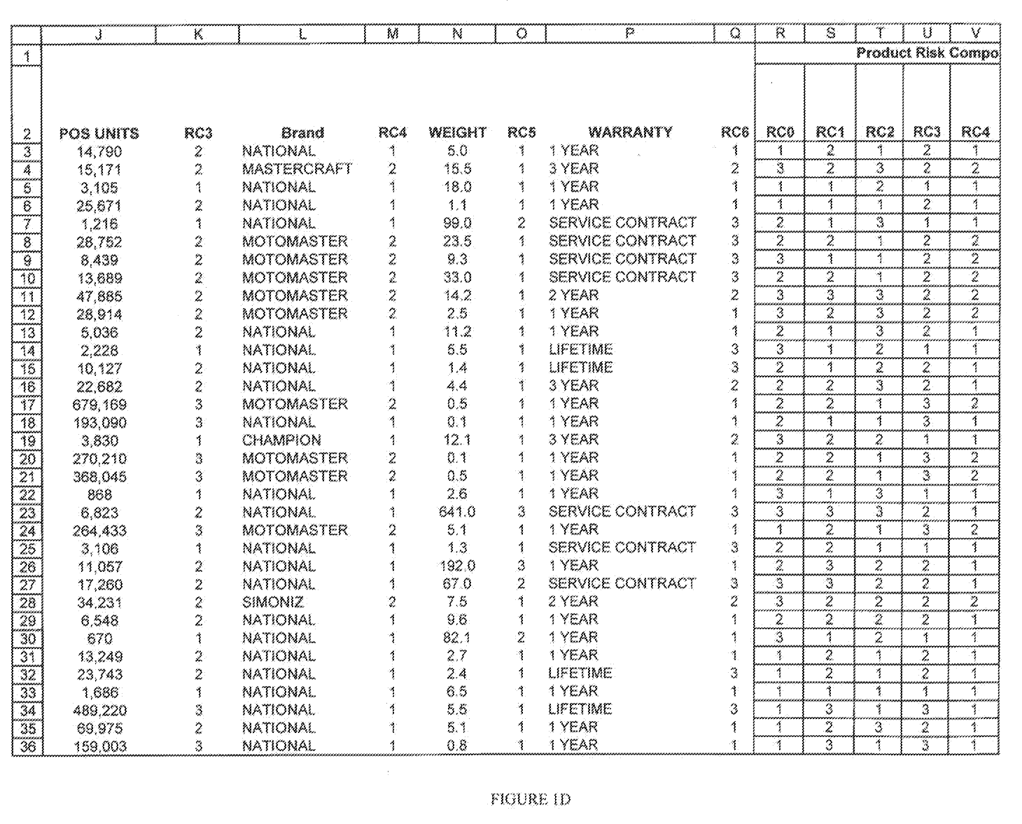

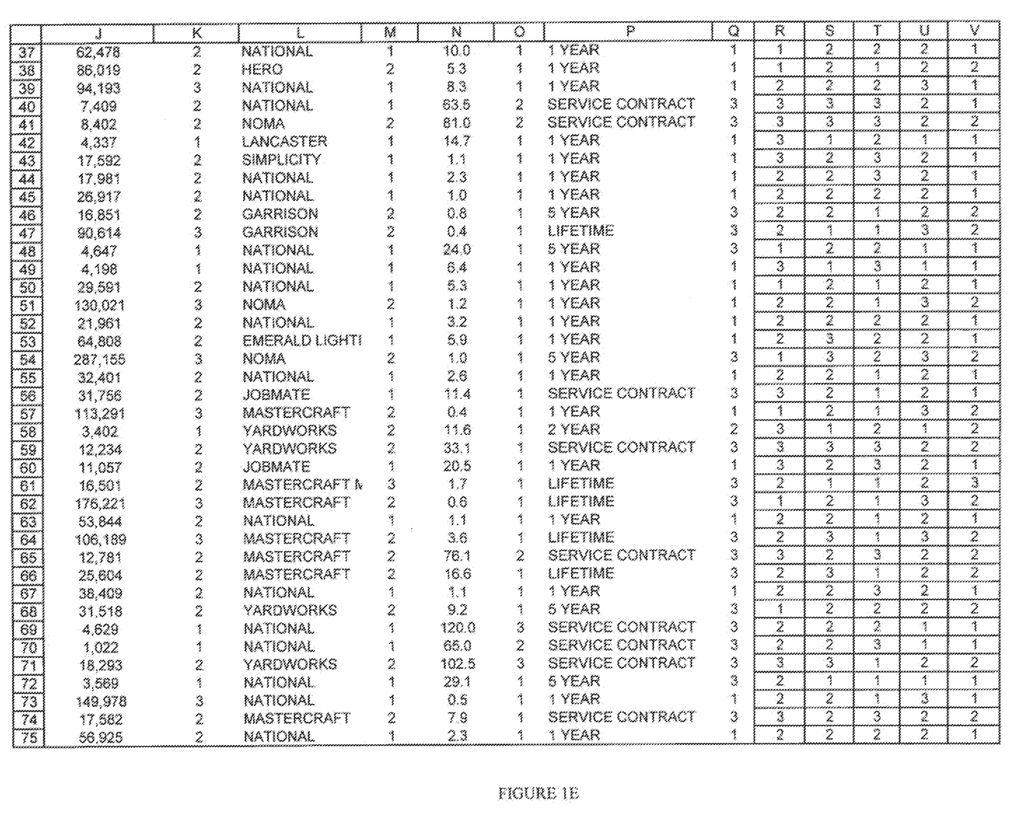

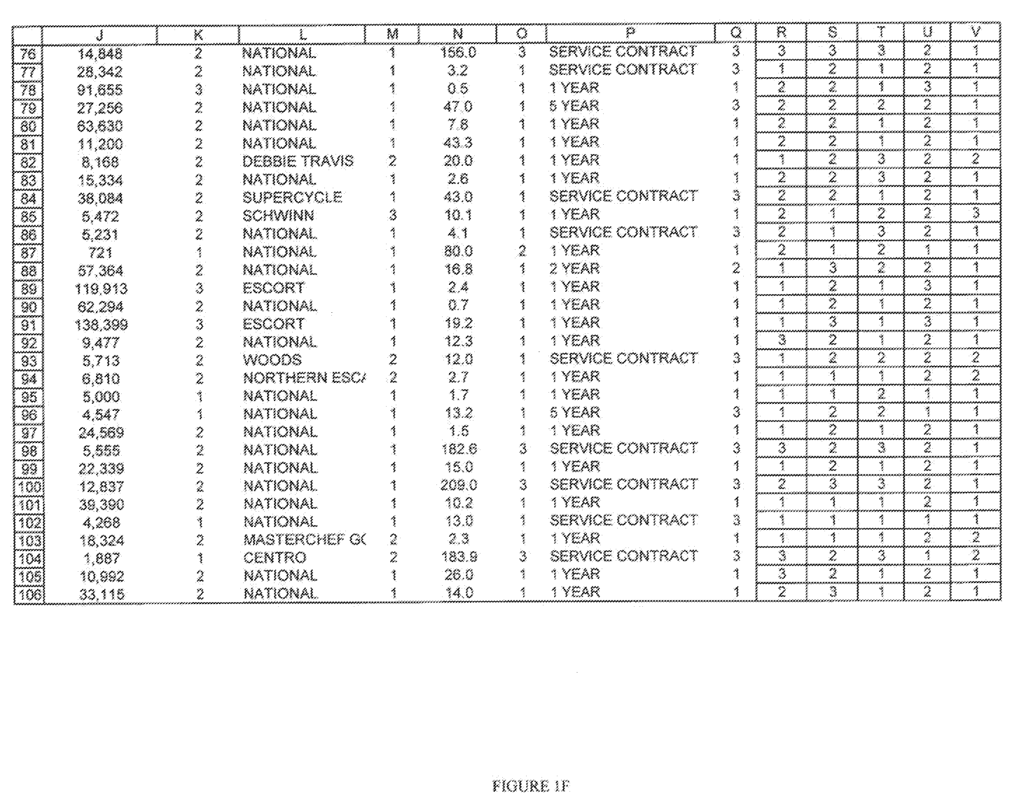

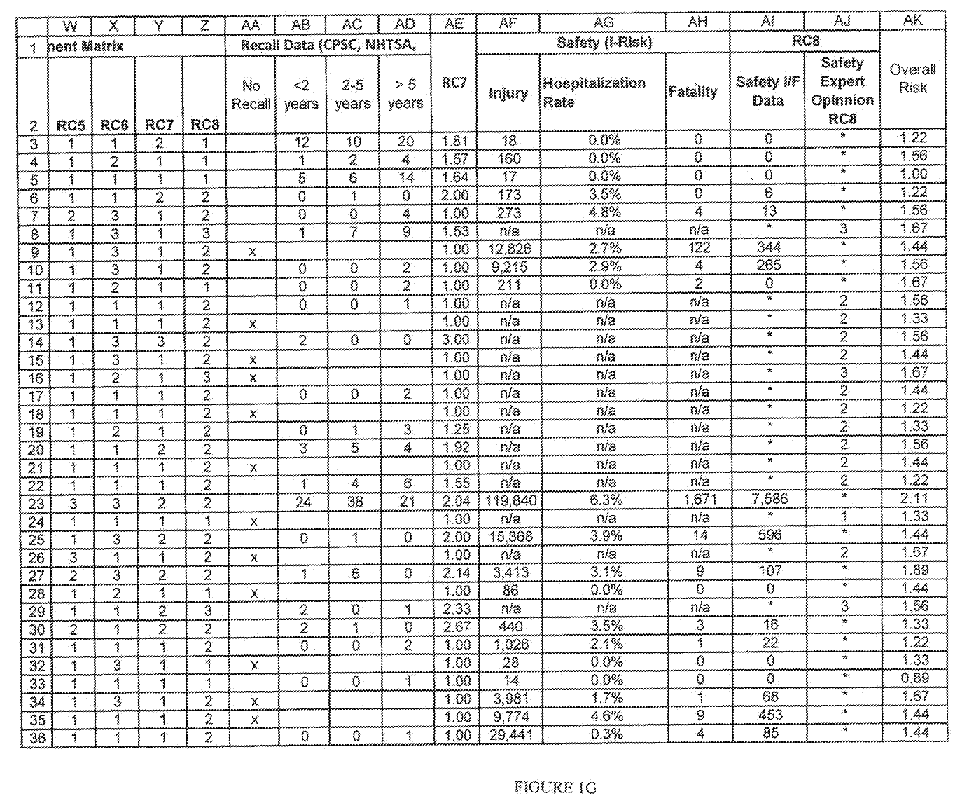

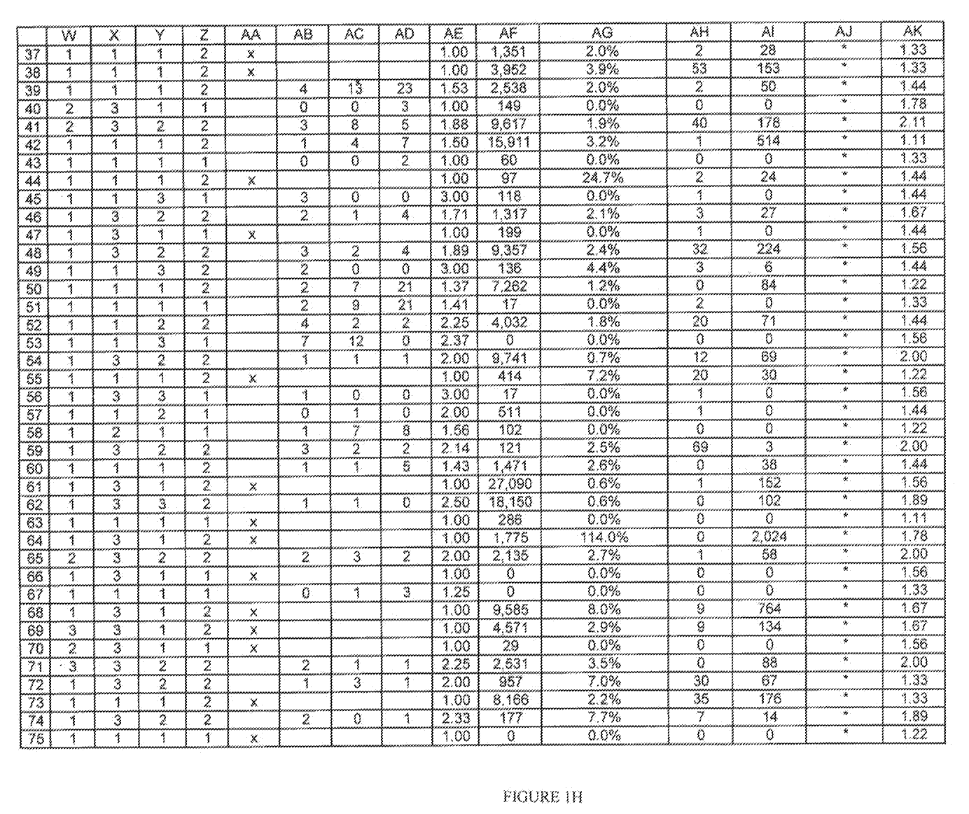

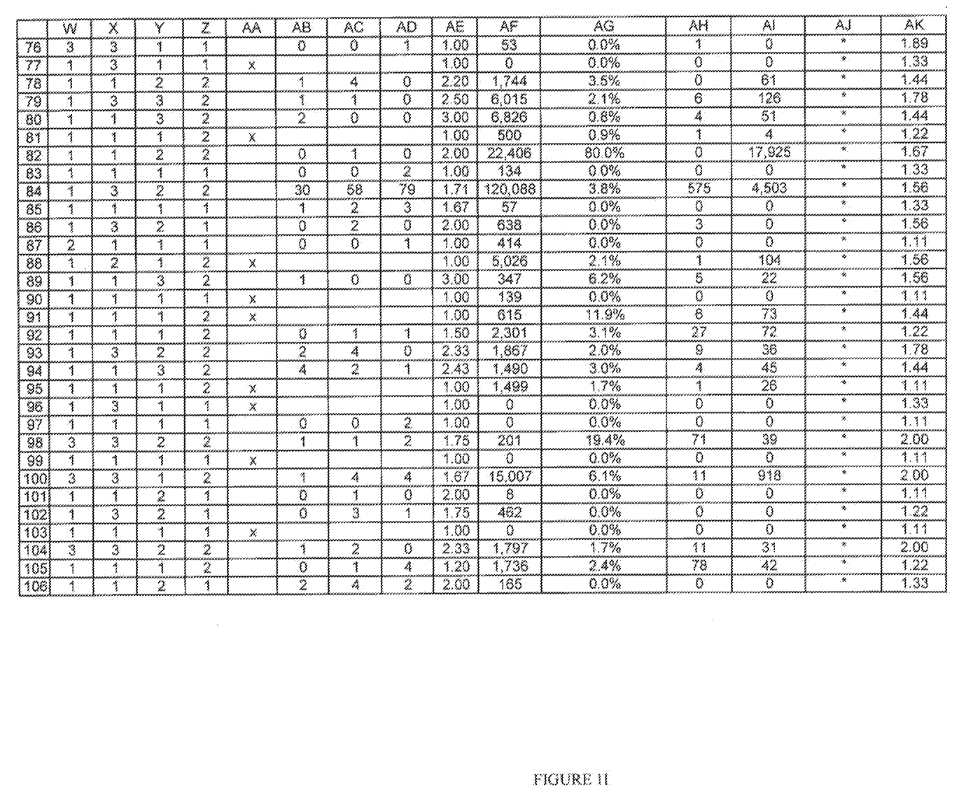

The ability of collecting relevant data and effectively utilizing it for decision making purposes has changed the landscape in supply chain management. Transparency of the supply chain may be critical for the success of any firm or company, and may be especially so when firms compete on short product life cycles and small margins. The future success of a supply chain may very be related to firms' ability to utilize technology to improve the performance of the entire supply chain. Information can be a competitive advantage for supply chains. FIGS. 1A-1I comprise an exemplary spreadsheet that illustratively demonstrates one type of data capture mechanism for collecting relevant data for computing product risk and supplier risk and related underlying contributing factors. FIGS. 1A-1I is meant to show possible factors related to product, supplier and/or other involved cost structures for computing overall total cost of ownership and related costs. Since a spreadsheet can be logically large, the FIGS. 1A-1I should be arranged as individual parts of a larger spreadsheet, that collectively form the spreadsheet.

### Exemplary Costs that may be Included in TCO Model

Price of a product:

FOB (freight on board or free on board) (e.g. purchased price to supplier)

### Transportation and Logistics:

Foreign inland
Container shipment/trailer costs
From DC to store
From store to DC for returns
From DC to supplier for returns
U.S. inland

### Insurance (CIFA)

### Accessorials

### Customs and Import:

Port costs
Broker fees
Duty (HTUSA tariff)
Customs inspection costs

### Inventory Costs:

Carrying costs during ownership
Inventory in-transit
Shrinkage (damage and theft)

### Overhead and Administration:

Sourcing staff budget
Quality management budget

Software programs and forms to control from purchase through return cycle

### Risk and Compliance:

### Compliance to C-TPAT

Compliance to company social responsibility policy

### Labor:

From receipt to inventory
Labor from store dock to shelf
Labor for returns to store dock
Labor to stock returns in appropriate location
Labor to process return to supplier
Labor for disposal of scrapped material

### Miscellaneous Costs:

Disposal of scrap
Loss of revenue from returns
Product life cycle costs (discounts, scrap, and sales below costs)

### Utilization of Total Cost of Ownership Model

The Total Cost of Ownership Model (TCO) may be utilized for many reasons. It may be one way to determine effectiveness of the supply chain in sourcing or a way for the importer to better understand the costs of the supply chain. By utilizing the model an importer may effectively review implications of previous decisions and make projections on changes that would alter the cost structure and improve the bottom line. The model might effectively be performed for a single product or a product category. It sometimes may not be recommended to be performed for the results of the entire company if the products imported are varied. Utilization of aggregate data for the entire firm may lead to not identifying potential opportunities for improvements.

### Product Analysis:

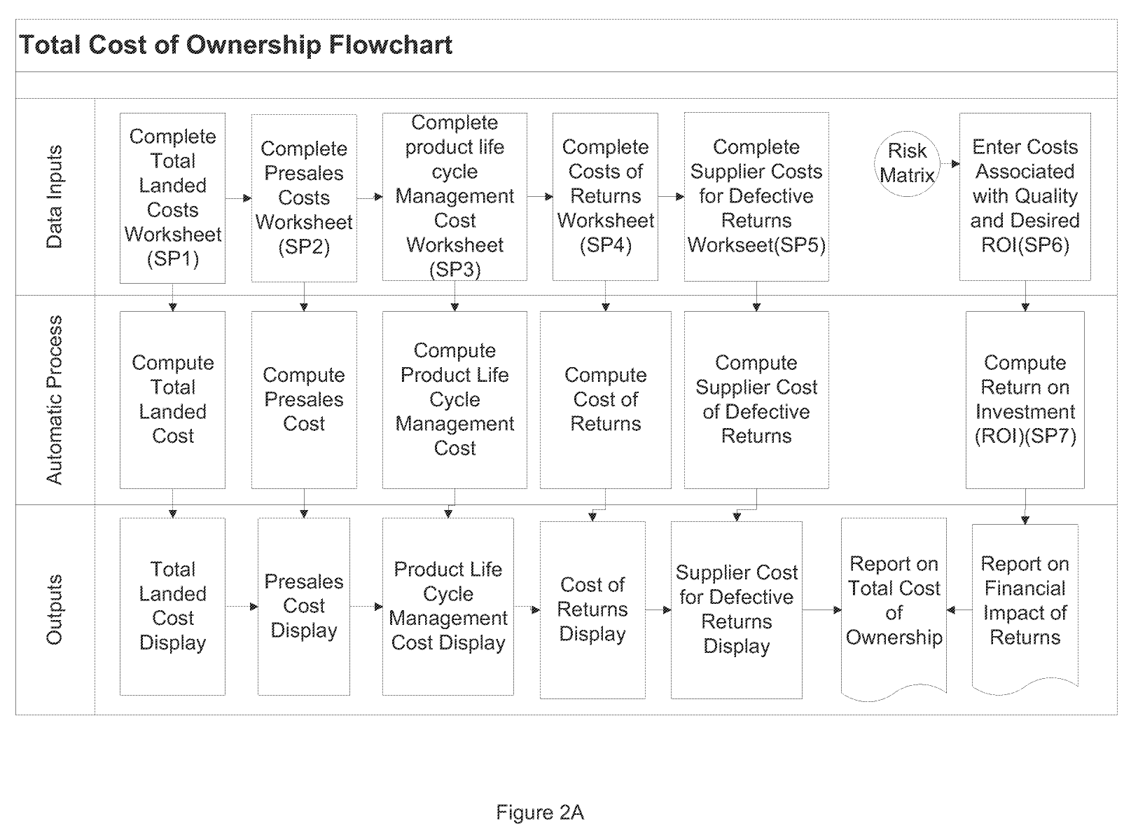

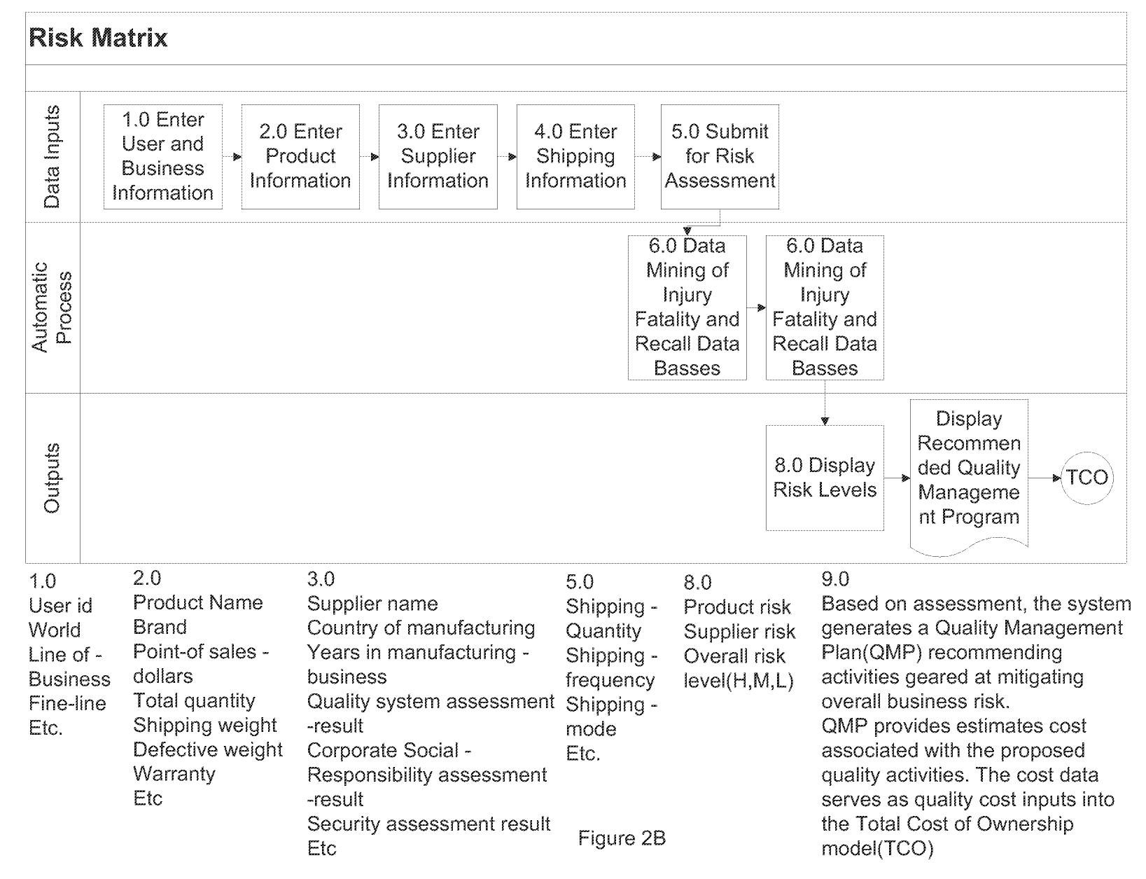

The ability to define a specific product may require granular information and at other times expert (usually from internal employees) input for the process. In many places the particular input is not a major cost and it is suggested that a small numeric number (less than a penny, for example) be utilized as a place holder. In other cases, it may require assumptions. For example, the varying sizes of women's blouses have impact upon the quantity per container, potentially. Utilization of an approximate average may be acceptable for the purposes of this example if they are not bought in a full container load but share a container with other products. The following is an exemplary process to determine specific costs utilizing the work sheets within the model, according to principles of the invention. The derived data are specifically marked as such and typically utilizes the company's data. The fields to be inputted are also designated throughout the model. The following description and process may be considered as portions of a spreadsheet representation (e.g., cells of a spreadsheet) that may also be representative of one or more software components of the tool for providing the inputting, processing and/or outputting of the model. The components including the sub-processes may be separate components or sub-processes that may be interfaced by a communication mechanism to provide results of one step to another within a computer system. The flowchart of FIG. 2A may have steps that can be organized logically. The steps labeled SP1 through SP7 in FIG. 2A may each include one more sub-steps (in nearly any combination depending on application, such as two, three, four, five, ten, or more sub-steps) that provide a subtotal cost or a basis, as described in more detail below.

### Total Landed Cost Worksheet (Labeled as SP1 in FIG. 2A)

Sub-step SP 1-1: Product or category description may be inputted

Sub-step SP1-2: Country of Origin of a product may be inputted

Sub-step SP1-3: FOB cost may be a calculated cost

Sub-step SP1-4: Cost to procure per unit from supplier at FOB point may be inputted.

Sub-step SP1-5: Transportation cost from FOB point to DC per unit may be calculated.

Sub-step SP1-6: Transportation cost of container that may be an inputted cost from contracts.

Sub-step SP1-7: Quantity shipped per container—may be an inputted number (e.g., as best approximated number for a full container load)

Sub-step SP1-8: Duty per unit may be calculated.

Sub-step SP1-9: Duty (tariff) rate may be an inputted figure based upon compliance to import regulations.

Sub-step SP1-10: Insurance fees per unit (CIFA) may be a calculated number and may be based upon contracts.

Sub-step SP1-11: Total CIFA costs may be inputted from budgets or historical numbers.

Sub-step SP1-12: Total value of product purchased may be inputted from historical numbers or from annual budget.

Sub-step SP1-13: Harbor fees/unit may be a calculated number.

Sub-step SP1-14: Harbor fees typically 0.5% of FOB may be an inputted fee from documents.

Sub-step SP1-15: Brokers fees/unit may be a calculated number; the more units per container the lower the costs per unit typically.

Sub-step SP1-16: Brokers fee per container may be an input number from contractual agreements. Sometimes importers have their in-house brokerage.

Sub-step SP1-17: Inspections cost/unit may be a calculated cost.

Sub-step SP1-18: Budgeted inspection costs or historical costs may be an inputted number for CBP inspections (which may be estimated).

Sub-step SP1-19: Total value of product purchased may be an inputted number based upon budgets or historical factors. It may be associated with the total product purchased for the organization.

Sub-step SP1-20: Labor costs/unit may be a calculated amount.

Sub-step SP1-21: Hourly rate of Distribution Center (DC) personnel may be an inputted number and may include allocation of benefits.

Sub-step SP1-22: Minutes to unload and locate product on container (may be a range, e.g., 240-420) may be an inputted number based upon historical figures and/or engineering calculations. It may be the time from being received at the dock door till it is put into storage for eventual shipment to stores, for example.

Sub-step SP1-23: Allocation of quality management costs/unit may be a calculated number.

Sub-step SP1-24: Budgeted cost of quality management may be an inputted number. It may include salaries, space, travel and other related costs.

Sub-step SP1-25: Total value of product purchased may be an inputted number.

Sub-step SP1-26: Allocation of sourcing costs/unit may be a calculated number.

Sub-step SP1-27: Budgeted costs of global sourcing may be an inputted number. It may include salaries, space, travel, and other items related to sourcing.

Sub-step SP1-28: Total value of product purchased may be an inputted number.

Sub-step SP1-29: Inventory costs for in-transit/unit may be a calculated number.

Sub-step SP1-30: Number of days to deliver from supplier to DC may be inputted. It may be an historical number from the FOB point to the dock door, for example.

Sub-step SP1-31: Cost of inventory in annual % may be an inputted field and is usually obtained from finance or accounting; or a similar function.

Sub-step SP1-32: Compliance costs for Customs-Trade Partnership Against Terrorism (C-TPAT)/unit may be a calculated number.

Sub-step SP1-33: Budget for C-TPAT compliance may be an inputted number.

Sub-step SP1-34: Total value of product purchased may be an inputted number.

Sub-step SP1-35: Compliance costs for social compliance/unit may be a calculated number.

Sub-step SP1-36: Budget for social compliance may be an inputted number.

Sub-step SP1-37: Total value of product procured may be an inputted number.

Sub-step SP1-38: Disposal costs of packaging materials and scrap at DC's/unit may be a calculated number.

Sub-step SP1-39: Disposal budget for DC's may be an inputted number.

Sub-step SP1-40: Total value of product purchased may be an inputted number.

Sub-step SP1-41: Damage and Theft (shrinkage) pre-shipment to stores may be a calculated number.

Sub-step SP1-42: Insert damage and theft rate (suggest between 0.1%-0.5%, but limited to this range) may be an inputted figure based upon history. This may be estimated when there is a lack of actual historical information.

Sub-step SP1-43: Total Landed Cost may be a calculated figure by adding all, or portions of the above, as relevant for an application, sub-totals.

### Presale Costs Worksheet (Labeled as SP2 in FIG. 2A)

Sub-step SP2-1: Landed cost may be a calculated field brought forward from a prior entry.

Sub-step SP2-2: Transportation cost to ship to store (per unit) may be a calculated field.

Sub-step SP2-3: Average cost to ship trailer from DC to stores—is an inputted number based upon average costs.

Sub-step SP2-4: Quantity on trailer (or conveyance) if totally filled with product may be inputted from an earlier number (e.g., from the Landed Cost worksheet). This typically assumes that the density stays relatively high whether it is filled or not with the same product.

Sub-step SP2-5: Labor cost at store to unload and stock product on shelf (per unit) may be a calculated number.

Sub-step SP2-6: Time to unload container and locate on shelf (may be, a range such as 200-480 minutes, for example) may be an inputted number and may be estimated if not known.

Sub-step SP2-7: Labor rate at stores may be an inputted number; it may include benefits as well as direct salaries.

Sub-step SP2-8: Shrinkage/unit (theft or damage) may be a calculated number.

Sub-step SP2-9: % damage or theft (range from 2%-6%, for example) may be an inputted number from the firm's statistics or historical information. The range may be based upon damage or theft studies performed.

Sub-step SP2-10: Inventory costs/unit may be a calculated field.

Sub-step SP2-11: Average days from stock until sale may be an inputted number based upon experience (e.g., inventory turns).

Sub-step SP2-12: Cost of inventory at annual percentage rate may be an inputted number obtained from finance or similar functional area.

Sub-step SP2-13; Disposal of materials at stores (not including DC's) may be a calculated number.

Sub-step SP2-14: Disposal budget may be an inputted number and may only be for stores.

Sub-step SP2-15: Total value of purchases may be an inputted number.

Sub-step SP2-16: Total presales cost may be a calculated number based upon totaling all of the above sub-totals for Pre-sale costs (SP2).

### Product Life Cycle Management Costs Worksheet (Labeled as SP3 in FIG. 2A)

Sub-step SP3-1: Losses due to in store discounted product may be a calculated field. This number may reflect the loss from sales below presales cost.

Sub-step SP3-2: % of goods discounted may be an inputted number. It may be based upon historical trends and can be assumed from category experiences.

Sub-step SP3-3: % below presales cost may be an inputted number based upon historical knowledge.

Sub-step SP3-4: Losses due to sales to discount companies may be a calculated field. This is typically for product sold to outlet stores not owned by the importer.

Sub-step SP3-5: % goods sold to discounters may be an inputted field based upon historical results.

Sub-step SP3-6: % below presales costs may be an inputted field based upon history.

Sub-step SP3-7: costs of goods scrapped per unit may be a calculated number, such as from Presales Cost of Goods Worksheet.

Sub-step SP3-8: % Goods scrapped may be an inputted field based upon historical statistics of product scrapped because of lack of sales.

Sub-step SP3-9: Total PLC management costs/unit may be a calculated number by totaling all of column C above on this worksheet.

### Cost of Returns Worksheet (Labeled as SP4 in FIG. 2A)

### Store Costs for Defective Returns/Unit

Sub-step SP4-1: Processing costs at stores (per unit) may be a calculated number.

Sub-step SP4-2: Stores cost of IT programs for returns may be an inputted number. Budget should be available or estimated.

Sub-step SP4-3: Cost of form for return (e.g., $0.02540.05) may be an inputted number and can be estimated if unknown.

Sub-step SP4-4: Number of annual returns may be an inputted number and refers to all returns to the firm.

Sub-step SP4-5: Labor including labor to process/unit may be a calculated number. This may be labor to handle the return process from the point the customer brings it till it is loaded to ship back to the DC.

Sub-step SP4-6: Labor time budgeted to process returns may be an inputted number from budgets. If not available, the number may be estimated from a range of 10 minutes-20 minutes (for example) each depending upon the products characteristics.

Sub-step SP4-7: Number of returns may be an inputted number and may be from historical numbers of defective returns. It is usually the total annual returns number.

Sub-step SP4-8: Labor hourly rate at stores may be an inputted number. This may include direct salary and benefits.

Sub-step SP4-9: Damage and/or theft costs and may be a calculated number (such as from Presales Worksheet).

Sub-step SP4-10: Loss of revenue, if refund only, and may be a calculated number.

Sub-step SP4-11: % of returns not exchanged may be an inputted number and may be based upon historical intelligence from data gathering or could be estimated.

Sub-step SP4-12: Margin loss by refund (suggested range of 30%-50%, but not limited to this range) may be an inputted number based upon policy of normal margins in the sale of product.

Sub-step SP4-13: Total for store costs of returns may be a calculated sum for all of sub-totals from above for Costs of returns (SP4).

### DC Costs for Defective Returns (Labeled as SP5 in FIG. 2A)

Sub-step SP5-1: Processing costs from receipt thru disposal—may be a calculated number.

Sub-step SP5-2: DC costs of IT support for returns may be an inputted number which may be obtained from budgets or estimated.

Sub-step SP5-3: Number of defective units returned may be an inputted number based upon historical records (or estimated).

Sub-step SP5-4: Labor costs from receipt through shipment may be a calculated number. It is the labor from arrival back to the DC through shipment to the supplier.

Sub-step SP5-5: Labor time budgeted to process returns may be an inputted time in annual hours based upon budgets. Estimate the time if budgets not available. This may also include salary employees' time to communicate with supplier.

Sub-step SP5-6: Labor hourly rate may be an inputted number based upon salary and benefits at the DC.

Sub-step SP5-7: Number of defective returns processed may be an inputted number. It is the annual number of defective returns.

Sub-step SP5-8: Damage and/or theft may be a calculated number of Presale Worksheet).

Sub-step SP5-9: Insert damage & theft rate (suggest between 0.1%-0.5%) may be an inputted number based upon history or estimated.

Sub-step SP5-10: Transportation per unit may be a calculated number. Cost of returning from store to DC.

Sub-step SP5-11: Cost store for full trailer may be an inputted number based upon statistics.

Sub-step SP5-12: Qty/full container may be an inputted number carried from earlier entry.

Sub-step SP5-13: Total for DC costs for defective returns may be a calculated number from above.

Sub-step SP5-14: Total Importer Costs for Defective Returns may be a calculated number.

### Supplier Costs for Defective Returns Worksheet (as Part of SP5 of FIG. 2A)

Sub-step SP5-15. Transportation/unit may be a calculated number.

Sub-step SP5-16. Cost from DC to Suppliers for full trailer may be an inputted number. The cost is borne by the supplier and typically is 75% of the cost from the supplier to the DC.

Sub-step SP5-17. Qty/full container may be an inputted number from earlier.

Sub-step SP5-18. Loss of sale impact may be a calculated number (8B*7C of Landed Cost Worksheet).

Sub-step SP5-19. Profit margin on product (10-15% common) may be an inputted number and can be estimated.

Sub-step SP5-20. Port costs/unit (use 0.5%) may be a calculated number (0.5%*7C of Landed Cost Worksheet)

Sub-step SP5-21. Broker fees/unit may be a calculated cost.

Sub-step SP5-22. Brokerage fees/container may be an inputted number and is contracted with brokers.

Sub-step SP5-23. Rework may be a calculated number based upon some assumptions due to lack of knowledge of supplier costs.

Sub-step SP5-24. Hours of rework including receiving returned material may be an inputted number. An estimate should be between 10-30 hours for every returned container.

Sub-step SP5-25. Labor rate in country of rework may be an inputted number and can be estimated.

Sub-step SP5-26. Number of units processed may be an inputted number based upon the units returned.

Sub-step SP5-27. Disposal may be a calculated number. It is based upon the estimated disposal cost of disposing scrap material.

Sub-step SP5-28. Cost of disposal may be an inputted cost.

Sub-step SP5-29. Number of units processed may be an inputted number.

Sub-step SP5-30. Complaint investigation may be a calculated number.

Sub-step SP5-31. Cost of defects return investigation may be inputted. It is the time and materials utilized to investigate issues in the product.

Sub-step SP5-32. Total number of units exported may be inputted. This is what the supplier has shipped totally for the product in question as opposed to a full container only.

Sub-step SP5-33. Penalties if any processed may be a calculated number.

Sub-step SP5-34. Total penalties cost may be an inputted number.

Sub-step SP5-35. Total number of units exported may be an inputted number.

Sub-step SP5-36. Total supplier costs for returns may be a calculated number by the addition of column C above.

### Financial Impact of Returns Worksheet

Fields requiring input: None—all fields are filled in by earlier entries.

### Total Cost of Ownership Worksheet

Fields requiring input: None—all the fields are brought over from previous calculations.

### Costs (Variable) Associated with Quality (Labeled as SP6 in FIG. 2A)

### Pre-Shipment Inspection Cost/Unit

Sub-step SP6-1. # Units may be inputted from the number of units that fit on a shipping container.

Sub-step SP6-2. Cost of service may be the cost of a pre-shipment inspection.

Sub-step SP6-3. Cost/unit of pre-shipment inspection may be calculated by 4C/48.

Sub-step SP6-4. Number of containers annually may be inputted by tracking the annual number of containers shipped per year from this supplier including other products is to be filled in.

Sub-step SP6-5. Process and/or factory audits may be calculated.

Sub-step SP6-6. Cost of service may be an inputted number (cost of the service to audit).

Sub-step SP6-7 Cost/unit may be calculated.

Sub-step SP6-8. Testing in units may be calculated.

Sub-step SP6-9 is an inputted number—the cost of the service for testing.

Sub-step SP6-10 may be a calculated number.

Sub-step SP6-11. Total variable cost of quality may be a calculated number.

### Returns on Investment (ROI) Work Sheet (Labeled as SP7 in FIG. 2A)

Sub-step SP7-1. Current defective return rate may be an inputted number from historical calculations.

Sub-step SP7-2. Return cost/unit at return rate may be a calculated number.

Sub-step SP7-3. Goal defective return rate may be an inputted number.

Sub-step SP7-4. Return cost/unit purchased may be a calculated number.

Sub-step SP7-5. Reduced cost/unit/unit purchased may be calculated.

Sub-step SP7-6. Cost of quality/unit purchased may be a calculated number.

Sub-step SP7-7. Cost of quality increase (such as 2× or 3×) may be an inputted estimate of the costs to get to the quality goals. Note—this area needs to include quality management costs and will, in next update.

Sub-step SP7-8. Increased cost of quality/unit may be a calculated number.

Sub-step SP7-9. Savings/unit purchased may be a calculated number.

Sub-step SP7-10. ROI—(return on investment) may be a calculated number.

FIG. 2A is a flow diagram showing an embodiment of a process, performed according to principles of the invention. The flow diagram of FIGS. 2A and 2B and all other flow diagrams, sub-steps and processes described herein may also be considered as a block diagram of the components for performing the steps thereof. The components may be hardware and/or software or combinations of both that perform the steps of the process. In some embodiments, one or more, or all of the components may be only hardware based components. In some embodiments, the components may be software that when executed on appropriate computing platform perform the steps thereto. The steps of the flow diagrams may be embodied as computer software logic, configured to execute the respective steps when read and executed by a computer, and stored on a readable computer storage device such as a memory, disk, or portable memory device such as a disc. The components of FIGS. 2A and 2B and/or the one or more other processes and sub-steps described herein may be interfaced with a network and/or databases, inter-communication mechanisms, and/or suitable user interfaces and displays to provide a system configured according to principles of the invention.

The Total Cost of Ownership embodiment of FIG. 2A includes several sub-processes (e.g., SP1, SP2, SP3, SP4, SP5) as indicated and described above. The flow diagram also is logically partitioned to illustrate the data inputs, the automatic processes and the outputs of the process. FIG. 2B is a flow diagram showing an embodiment of a process performed according to principles of the invention, showing a Risk Matrix that includes computing a risk assessment.

The embodiment of FIG. 2A and the embodiment of FIG. 2B may be utilized independent of one another, or alternatively the embodiments may be used as a combined overall process.

When utilized independently, either embodiment may be a part of a computer platform and/or system that provides appropriate user interfaces, displays, processors and memories; and/or may be stored on a computer readable medium. The processes of FIG. 2A and FIG. 2B may also be block diagrams of the components for performing the steps thereof.

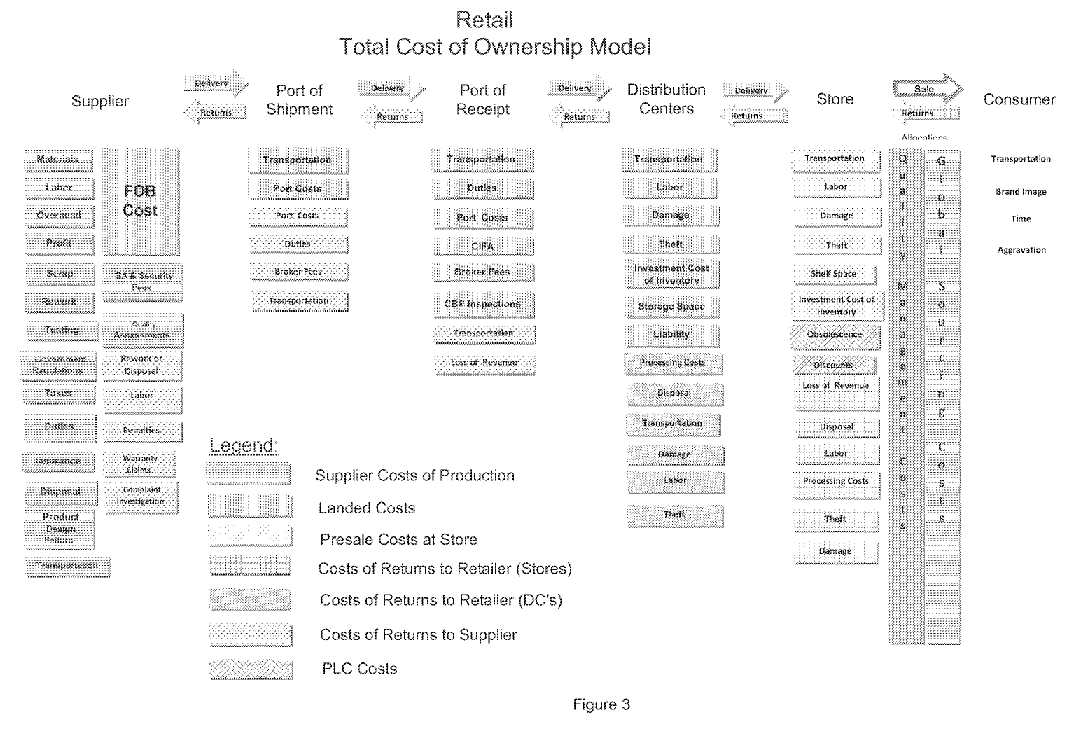

FIG. 3 is a functional block diagram showing participants of the overall process, and exemplary cost data that may be involved in the various stages, configured and performed according to principles of the invention. The total cost of ownership model of FIG. 3 shows costs associated with a supplier, port of shipment, port of receipt, distribution centers, a store and a consumer. The costs are further described by cost type as shown by the legend, including supplier costs of production, landed costs, presale costs, costs of returns to retailer, costs of returns to supplier, and PLC costs. Moreover, costs associated with quality management and global sources are also shown as part of the total cost of ownership model. Each of these costs may be quantified and applied to a risk assessment for total cost of ownership.

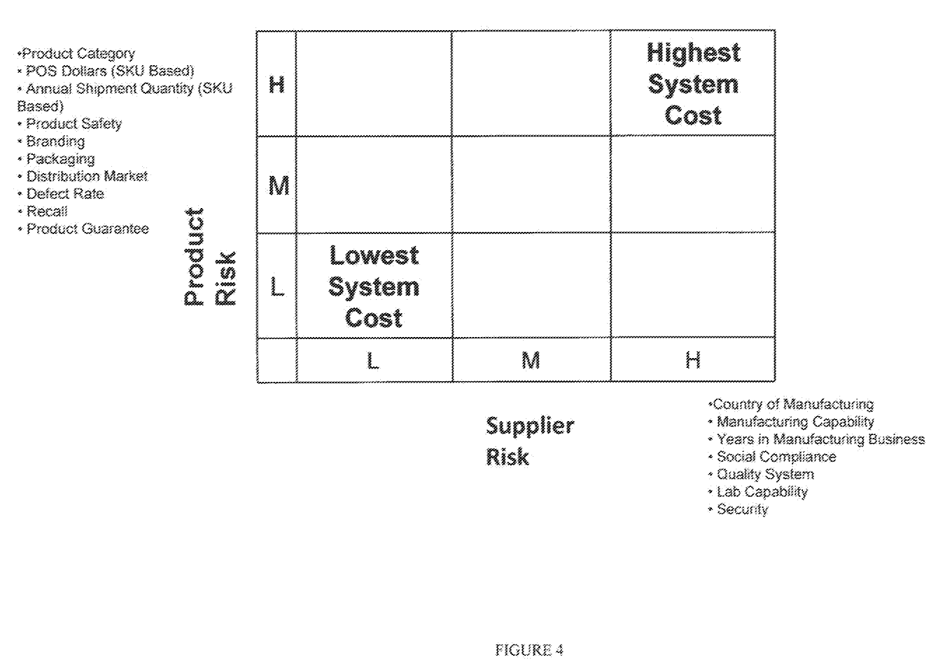

FIG. 4 is a diagram conceptually showing exemplary factors comprising a supply system cost. The diagram of FIG. 4 shows product risk along the vertical axis. The product risk might include, for example, but not limited to: a product category, point of sale dollars, annual shipment quantity, product safety, branding, packaging, distribution market, defect rate, recall/recall history, product guarantee. Supplier risk is shown along the horizontal axis. The supplier risk may include, for example, and not limited to: a country of manufacture, manufacturing capability, years in manufacturing business, social compliance, quality system, lab capability, and security. Each of these contributing factors (comprising product risk and supplier risk) may be quantified and plotted. The result of the plot may represent an overall system risk that ranges from a low cost system to a moderate cost system to a high cost system. The diagram of FIG. 4 is exemplary, and other rating methods and/or outputs could be employed, such as Venn diagrams or bar chart, for example. The result may be used to change a product, a product attribute, a supplier, or to change an attribute associated with a supplier. The change may include foregoing a current product or supplier for another product or supplier, for example. The overall risk of a product and/or supplier, which is related to the total cost of ownership, may be related to a return on investment (ROI) goal or calculation. If the risk causes a ROI to be compromised or threatened, or even to be below expectations, for example, then a change to supplier and/or product may be effected, as deemed appropriate.

The examples given above are merely illustrative and are not meant to be an exhaustive list of all possible embodiments, applications or modifications of the invention. Thus, various modifications and variations of the described methods and systems of the invention will be apparent to those skilled in the art without departing from the scope and spirit of the invention.

Although the invention has been described in connection with specific embodiments, it should be understood that the invention as claimed should not be unduly limited to such specific embodiments. The invention may be implemented as part of a computer or a computer platform that includes appropriated input and output interfaces, user interfaces such as a display, storage mediums for storing the components configured according to principles of the invention (such as the components of FIG. 1A-1I, and/or FIGS. 2A and 2B), memories and power. The computer or computer platform may include a network and client/server operations, and may cause execution of embodiments herein and perform the processes according to principles of the invention. Indeed, various modifications of the described modes for carrying out the invention which are obvious to those skilled in the art or related fields are intended to be within the scope of the appended claims. Moreover, the Appendix attached herewith is incorporated herein and provides additional and/or an alternate description of the principles of the invention.

What is claimed is:

1. A system including a processor and memory for computing total cost of ownership comprising a plurality of components in the system to:
a) compute landed costs of at least one product;
b) compute presales cost of the at least one product;
c) compute a cost of return of the at least one product;
d) compute a supplier cost of defective returns;
e) generate risk levels associated with the at least one product; and
f) compute and output a total cost of ownership based at least in part on steps a-e, so that a change in a supply channel or a product occurs.
wherein the each component is embodied as part of a computer platform.

2. A computer program product embodied on computer storage medium for computing a total cost of ownership, the computer program product comprising computer instructions that when executed performs the steps of:
(a) computing a total landing cost for at least one product;
(b) computing a presales cost for the at least one product;
(c) computing a product life cycle management cost for the at least one product;
(d) computing a cost of returns for the at least one product;
(e) computing a supplier cost for defective returns for the at least one product;
(f) computing a cost associated with quality for the at least one product; and
(g) computing total cost of ownership by summing a result from each step (a) through (f),
wherein each of the steps (a) through (g) when executed are configured to be performed by a computer.

3. The computer program product of claim 2, wherein the total landing cost for a product unit include a plurality of costs selected from:
(a) a freight on board (FOB) cost;
(b) a cost to procure per unit from supplier at FOB;
(c) a transportation cost from FOB point to distribution center (DC) per unit;
(d) a transportation cost of a container of product;
(e) a cost of duty per unit;
(f) a duty cost;
(g) an insurance fees;
(h) a CIFA cost;
(i) a total value of product;
(j) a harbor fee;
(k) a brokers fee;
(k) a brokers fee per container;
(l) an inspections cost;
(m) a labor cost;
(n) a quality management cost;
(o) a sourcing cost;
(p) a cost of global sourcing;
(q) an inventory cost for in-transit;
(r) a cost of inventory;
(s) a compliance cost for Customs-Trade Partnership Against Terrorism (C-TPAT);
(t) a compliance cost for social compliance;
(u) a disposal cost of packaging materials and scrap; and
(v) a damage and theft cost.

4. The computer program product of claim 3, wherein the plurality of costs includes at least ten of the costs (a) through (v).

5. The computer program product of claim 2, wherein the presales costs includes at least a plurality of:
(a) a landed cost;
(b) a transportation cost;
(c) a cost to ship a product from distribution center to a store;
(d) a labor cost;
(e) a shrinkage cost;
(f) an inventory cost;
(g) a disposal of materials cost; and
(h) a total value of product.

6. The computer program product of claim 2, wherein the product life cycle management cost includes at least one of:
(a) a cost due to a loss related to an in store discounted product;
(b) a cost of goods discounted;
(c) a loss due to sales to discount companies;
(d) a cost of goods sold to discounters;
(e) a cost of goods scrapped; and
(f) a PLC management cost.

7. The computer program product of claim 2, wherein the cost of returns includes at least one of:
(a) processing costs at a store;
(b) a store cost of an information technology (IT) program for returns;
(c) a cost of a form for a return;
(d) a labor cost;
(e) a damage or theft cost;
(f) a loss of revenue; and
(g) a margin loss by refund.

8. The computer program product of claim 2, wherein the supplier cost of defective returns includes at least one of:
(a) a cost from distribution center to a supplier;
(b) a loss of sale cost;
(c) a port cost;
(d) a broker fee;
(e) a rework cost;
(f) a disposal cost;
(g) a cost of defects; and
(h) a penalty cost.

9. The computer program product of claim 2, wherein the cost associated with quality includes at least one of:
(a) a cost of service;
(b) a cost of pre-shipment inspection;
(c) a cost of a factory audit; and
(d) a cost of testing.

10. The computer program product of claim 2, further including generating a supplier risk and a product risk based at least in part on one or more of the computed costs from steps (a) through (g).

11. A computer program product embodied on computer storage medium for computing a total cost of ownership, the computer program product comprising computer instructions that when executed performs the steps of:
determining a product risk for at least one product;
determining a supplier risk associated with the at least one product; and
generating an overall risk based on the determined product risk and the determined supplier risk to cause a change in one of the at least one product and the supplier,
wherein each of the steps are configured to be executed by a computer.

12. A computer program product of claim 11, wherein the generated overall risk is relatable to a return on investment.
